(19) United States
(12) Patent Application Publication
(10) Pub. No.: US 2024/0249499 A1
(43) Pub. Date: Jul. 25, 2024

(54) AUTOMATED PRE-PROCESSING FOR TWO-DIMENSIONAL TO THREE-DIMENSIONAL MODELING ACCELERATION

(71) Applicant: Dell Products L.P., Round Rock, TX (US)

(72) Inventors: Anzhou Hou, Shanghai (CN); Zhen Jia, Shanghai (CN); Victor Fong, Medford, MA (US); Zhisong Liu, Shenzhen (CN)

(21) Appl. No.: 18/098,790

(22) Filed: Jan. 19, 2023

(51) Int. Cl. G06V 10/70; G06T 17/00

(52) U.S. Cl. CPC G06V 10/70; G06T 17/00

(57) ABSTRACT

Techniques are disclosed for managing digital models in computing environments configured to virtually represent objects in a physical infrastructure. For example, a method comprises detecting an object in a two-dimensional image and identifying an object type of the detected object. The method further comprises selecting, based on the identified object type of the detected object, an algorithm from a plurality of algorithms configured to transform a two-dimensional image into a three-dimensional model.

### FIELD

The field relates generally to computing environments, and more particularly to managing digital models in computing environments configured to virtually represent physical infrastructure.

### BACKGROUND

Recently, techniques have been proposed to attempt to represent physical infrastructure (e.g., a physical environment with one or more physical objects) in a virtual manner to more effectively understand, simulate, manage, manipulate, or otherwise utilize the physical infrastructure.

One proposed way to represent physical infrastructure is through the creation of a digital twin architecture. A digital twin typically refers to a virtual representation (e.g., virtual copy) of a physical (e.g., actual or real) product, process, and/or system. By way of example, a digital twin can be used to understand, predict, and/or optimize performance of a physical product, process, and/or system to achieve improved operations in the computing environment in which the product, process, and/or system is implemented.

Another proposed way to represent physical infrastructure is through the creation of a metaverse-type virtual representation. The metaverse is a term used to describe an immersive virtual world accessible through virtual/augmented/mixed reality (VR/AR/MR) headsets operatively coupled to a computing platform, enabling users to virtually experience a physical environment. By way of example, a metaverse-type virtual representation can enable users to virtually experience a wide variety of applications including, but not limited to, healthcare, training, gaming, etc. Many other examples of representing physical infrastructure through the creation of virtual representations associated with VR/AR/MR applications exist.

However, management of digital models (of physical objects) in computing environments configured to virtually represent physical infrastructure (e.g., digital twin, metaverse, VR/AR/MR applications, etc.) can be a significant challenge.

### SUMMARY

Embodiments provide techniques for managing digital models in computing environments configured to virtually represent objects in a physical infrastructure.

According to one illustrative embodiment, a method comprises detecting an object in a two-dimensional image and identifying an object type of the detected object. The method further comprises selecting, based on the identified object type of the detected object, an algorithm from a plurality of algorithms configured to transform a two-dimensional image into a three-dimensional model.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a model generator environment according to an illustrative embodiment.

FIG. 2 illustrates a model generator according to an illustrative embodiment.

FIG. 3 illustrates a model management methodology according to an illustrative embodiment.

FIG. 4 illustrates a processing platform for an information processing system used to implement model generation functionality according to an illustrative embodiment.

### DETAILED DESCRIPTION

Illustrative embodiments will now be described herein in detail with reference to the accompanying drawings. Although the drawings and accompanying descriptions illustrate some embodiments, it is to be appreciated that alternative embodiments are not to be construed as limited by the embodiments illustrated herein. Furthermore, as used herein, the term “includes” and its variants are to be read as open-ended terms that mean “includes, but is not limited to.” The term “based on” is to be read as “based at least in part on.” The term “an embodiment” and “the embodiment” are to be read as “at least one example embodiment.” The terms “first,” “second,” and the like may refer to different or the same objects. Other definitions, either explicit or implicit, may be included below.

It is realized herein that virtual or digital models are a vital part for immersive experiences in applications such as the metaverse and digital twin architectures, and how such digital models are built will impact the effectiveness of the virtual world.

More particularly, three-dimensional (3D) models are some of the basic components used to build a digital twin, a metaverse implementation, or any AR/VR/MR rendering. For example, in such applications, one or more 3D models are generated to represent one or more objects in the physical infrastructure being virtually represented by the application.

Further, users can build 3D scenes by themselves or combine 3D models by procuring them from available websites or by otherwise obtaining them. For example, users can design and create 3D models of objects by software such as 3DMAX, Maya, etc. Another way is using 3D scanners to scan the physical object in the real world to create one or more virtual 3D models of the objects.

SOTA is an acronym for State-Of-The-Art in the context of Artificial Intelligence (AI) and refers to the appropriate models that can be used for achieving results in a task. Currently, SOTA in the context of AI includes the concept of Neural Radiance Fields (NeRF) and its variant algorithms that are configured to transform two-dimensional (2D) images to 3D models to speed up creation of the 3D models, i.e., 2D-to-3D modeling acceleration. However, users do not readily know which of the many variants of the NeRF algorithm can be used in which use cases. By way of example only, some NeRF variants include Nerfies (e.g., for face optimization), HumanNeRF (e.g., for human body optimization), NeRF-in-the-wild (e.g., for outdoor environment optimization), and KiloNeRF (e.g., for splitting models to leverage multiple graphical processing units (GPUs) to accelerate the processing), to name a few.

It is realized herein that when the NeRF algorithm variant is poorly selected, one or more significant disadvantages ensue. For example, the performance of the underlying computing environment (e.g., computing resources such as, e.g., compute nodes, storage nodes, network nodes, etc.) used to process the NeRF algorithm is negatively impacted. Unfortunately, typical users, even with AI knowledge, have difficulty determining the best performing NeRF algorithm to use to create 3D models in their particular use case, and thus cannot leverage these algorithms in a better way.

The training process from 2D images to 3D models is a computation intensive task which needs powerful GPUs or some other type of accelerators. Some NeRF variants can split a bigger model to a smaller number of sub-models to best utilize multiple GPUs to accelerate the processing. It is realized herein that knowledge of how many sub-models in which to split a bigger model, and the number of GPUs (i.e., computing resources) available in the system, will impact the processing performance. Typical users do not possess this knowledge and no existing systems automatically leverage this information in 2D-to-3D modeling acceleration.

Illustrative embodiments provide technical solutions that overcome the above and other challenges with existing digital model management by providing automated pre-processing for 2D-to-3D modeling acceleration. More particularly, in one or more illustrative embodiments, the automated pre-processing comprises performing object detection to detect one or more objects in one or more 2D images, selecting an appropriate (e.g., optimal, substantially optimal, best, proper, desirable, needed, etc.) 2D-to-3D algorithm based on object detection results, and then re-building the algorithm based on computing resource utilization/availability.

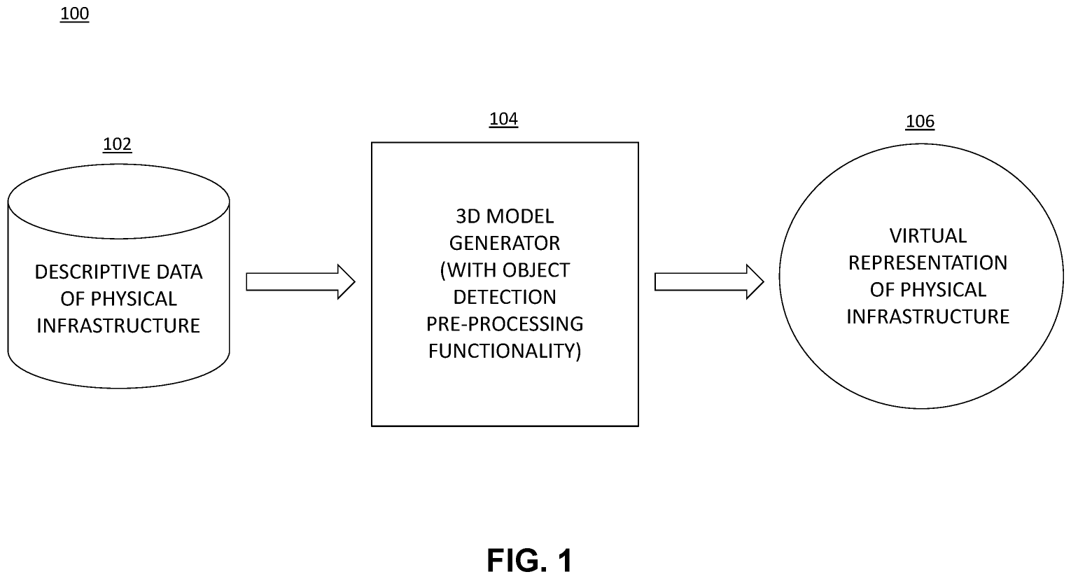

Referring initially to FIG. 1, a model generator environment 100 is generally depicted according to an illustrative embodiment. As shown, descriptive data of a physical infrastructure 102 (e.g., 2D images of one or more objects in the physical infrastructure) is input to a 3D model generator 104. As will be explained in further detail herein, 3D model generator 104 comprises object detection pre-processing functionality which enables automated selection of an appropriate 2D-to-3D algorithm based on at least a portion of descriptive data of the physical infrastructure 102. In accordance with the selected 2D-to-3D algorithm, 3D model generator 104 then renders a virtual representation of the physical infrastructure 106. The virtual representation can be used, by way of example only, in digital twin, virtual-immersion, VR/AR/MR, and any computer vision or AI applications.

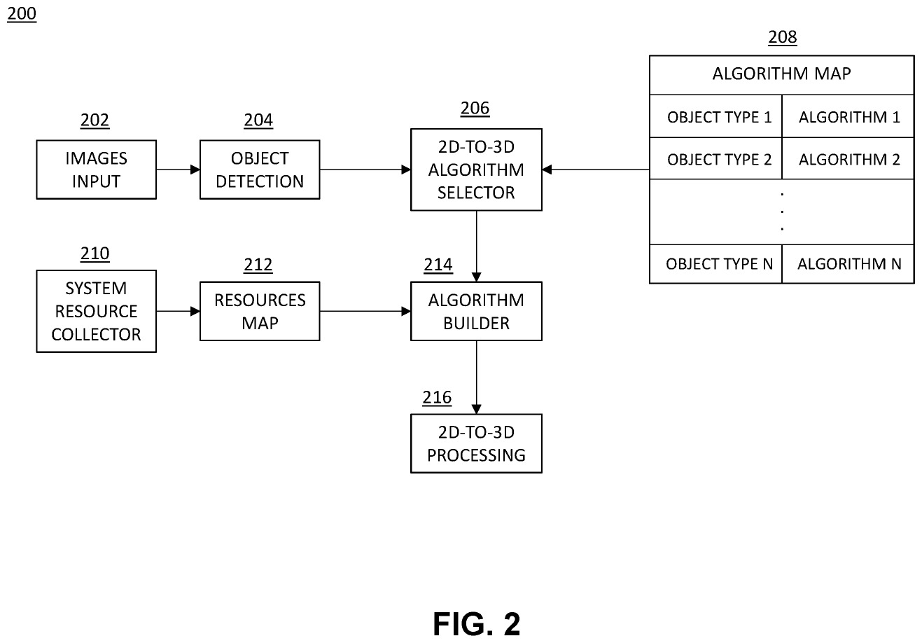

FIG. 2 illustrates a 3D model generator 200 according to an illustrative embodiment. More particularly, 3D model generator 200 is one example embodiment of 3D model generator 104 of FIG. 1. As shown, 3D model generator 200 comprises images input 202, an object detection module 204, a 2D-to-3D algorithm selector 206, an algorithm map 208, a system resource collector 210, a resources map 212, an algorithm builder 214, and a 2D-to-3D processing module 216, as will be further explained below.

Object detection module 204 receives images input 202, which comprises one or more 2D images of the physical infrastructure being digitally modeled. Object detection module 204 detects one or more objects in the one or more 2D images for 2D-to-3D modeling. Depending on the nature of the physical infrastructure being modeled (e.g., human faces and/or bodies, nature, other tangible items, etc.), different commercially or otherwise publicly available object detection techniques (e.g., hardware, software, or combinations thereof) can be utilized by object detection module 204. Examples of object detection techniques include, but are not limited to, computer vision-based object detection, AI-based object detection, image processing-based object detection, and the like, as well as combinations thereof. The output of object detection module 204 comprises the type of the object that is detected in an input 2D image.

The output of object detection module 204 (i.e., object type) is provided to 2D-to-3D algorithm selector 206 which is operatively coupled to algorithm map 208. Algorithm map 208 maintains a pre-defined correspondence between a plurality of object types (i.e., object type 1, object type 2, . . . , object type N) and a plurality of 2D-to-3D algorithms (i.e., algorithm 1, algorithm 2, . . . , algorithm N) configured to transform 2D images to 3D models.

For example, assuming the object type detected by object detection module 204 is a human face, then algorithm map 208 defines that the Nerfies algorithm be selected by 2D-to-3D algorithm selector 206. Further, assuming the object type detected by object detection module 204 is a human body, then algorithm map 208 defines that the HumanNeRF algorithm be selected by 2D-to-3D algorithm selector 206. Still further, assuming the object type detected by object detection module 204 is an outdoor environment, then algorithm map 208 defines that the NeRF-in-the-wild algorithm be selected by 2D-to-3D algorithm selector 206. In a case where object detection module 204 detects an object type that is not pre-defined in algorithm map 208, or even fails to detect a specific object type, a default can be selected as the generalized (non-variant) version of the NeRF algorithm. It is to be appreciated that while FIG. 2 illustrates a one-to-one correspondence between an object type and a 2D-to-3D algorithm, it is to be appreciated that multiple object types can be pre-defined as corresponding to the same algorithm. Alternatively, there may be a many-to-one correspondence with respect to algorithms to object type when two or more algorithms are equally well-suited to be used for the given object type. As such, 2D-to-3D algorithm selector 206 can be given multiple appropriate 2D-to-3D algorithms based on the object type, and 2D-to-3D algorithm selector 206 can select one of the algorithms based on predetermined criteria.

System resource collector 210 collects data indicating total and available resources of the underlying computing environment (i.e., system resources) being used to execute the 3D model generator 200. In one or more illustrative embodiments, such data collection can occur one or more of prior to, substantially in parallel with, or otherwise contemporaneous with, the above-described object detection and algorithm selection. In one illustrative embodiment, the underlying computing environment comprises one or more accelerator processors (e.g., one or more graphics processing units (GPUs), one or more tensor processing units (TPUs), etc.) that are configured to execute a selected 2D-to-3D algorithm. As such, in one or more illustrative embodiments, the collected data may comprise data indicative of accelerator types (e.g., GPU, TPU, etc.), accelerator versions, the number of accelerators, and updated accelerator utilization data, e.g., historical data indicating what accelerator types, versions, numbers (quantities), etc. were utilized for one or more previous executions of a selected NeRF algorithm. Also, the collected data may include current availability of accelerators to execute the selected 2D-to-3D algorithm.

Resources map 212 receives the collected data from system resource collector 210 and maintains a map of the system resources with the corresponding data indicating accelerator types, versions, quantities, utilization data, availability data, as described above, along with other accelerator indicia as may be needed or desired.

Algorithm builder 214 then utilizes the mapped resource data to build (e.g., re-build or otherwise adapt) the parameters of the algorithm selected by 2D-to-3D algorithm selector 206. More particularly, for example, algorithm builder 214 combines the selected NeRF algorithm and the parameters which are transformed from resources map 212 to build a new refined NeRF algorithm. For example, the NeRF algorithm and its variants can be partitioned into a plurality of sub-modules (i.e., where the partition number or how many sub-modules the algorithm can be partitioned into, is the parameter) according to the available resources. For example, the number of sub-modules can be determined from data obtained from resources map 212 based on historical data (e.g., experiential data). If a re-build of the selected algorithm is not successful, 3D model generator 200 can default to the generalized NeRF algorithm.

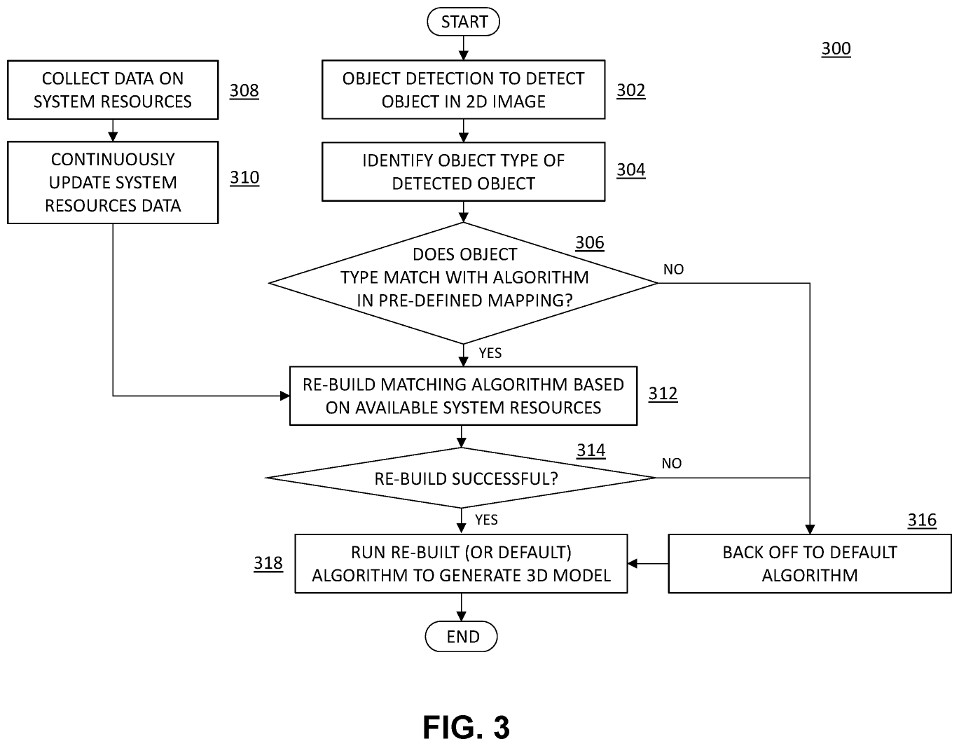

Turning now to FIG. 3, a model management methodology 300 is illustrated according to an illustrative embodiment. It is to be appreciated that model management methodology 300 comprises one example of steps of an operation flow that 3D model generator 200 and its constituent components can execute and/or otherwise cause to be executed. However, it is to be appreciated that model management methodology 300 is not limited to 3D model generator 200 in FIG. 2 and can be performed in other 3D model generation architectures and configurations.

As shown, step 302 performs object detection to detect an object in a 2D image.

Step 304 identifies an object type of the detected object.

Step 306 determines whether the object type matches with a 2D-to-3D algorithm in a pre-defined mapping (i.e., object type-to-algorithm mapping).

Step 308 collects data on system resources, wherein collection can be performed one or more of prior to, substantially in parallel with, or otherwise contemporaneous with, one or more of steps 302 through 306. As explained above, for the underlying computing system that is executing the 3D model generation and execution, collected system resources data can include, but is not limited to, data indicating accelerator types, versions, quantities, past utilization data, and current availability data, along with other accelerator indicia as may be needed or desired.

Step 310 continuously updates the system resources data collection.

Returning to step 306, when there is a match between the identified object type of the object detected in the 2D image and a 2D-to-3D algorithm in the pre-defined object type-to-algorithm mapping, step 312 re-builds the matching 2D-to-3D algorithm based on the available system resources determined from the data collected in steps 308 and 310. As explained above, re-building may include adapting the 2D-to-3D algorithm based on one or more parameters (e.g., algorithm task partitioning into sub-modules based on the number of available accelerators).

Step 314 determines whether the re-build is successful or not. The success of the re-build is dependent on the type of the selected algorithm and the underlying computing system that will execute it.

When step 306 determines that there is no algorithm match for the object type, or step 314 determines the re-build is unsuccessful, model management methodology 300 backs off to a selection of a default 2D-to-3D algorithm in step 316. In one example, the default can be the generalized NeRF algorithm.

Step 318 then executes the re-built algorithm if the re-build is successful (as per step 314), or the default algorithm (as per step 316). The executed algorithm results in a 3D model of the object detected in the 2D image. As mentioned herein, by way of example only, the 3D model can be used as part of a digital twin, a metaverse, VR/AR/MR, or any computer vision or AI application.

By way of one example only, assume a user imports 20 human body photos with high resolution (e.g., 4096*2160) from different views. Object detection detects a human body object in each of the images. The system selects the HumanNeRF algorithm from the NeRF algorithms map to train the models to accelerate the 2D-to-3D modeling instead of the general NeRF algorithm. The system also monitors the available GPUs, and if the available GPU number is N (N>=2), the HumanNeRF algorithm can be split (using the KiloNeRF algorithm) into N batches of sub-models (e.g., each sub-model is executed by a sub-module of the HumanNeRF algorithm) to accelerate the processing.

Advantageously, as described herein, illustrative embodiments provide techniques for automated pre-processing for 2D-to-3D modeling acceleration. The pre-processing adds object detection to detect the object, selects the proper algorithm by its output, and then re-builds the algorithm model based on the resource utilization.

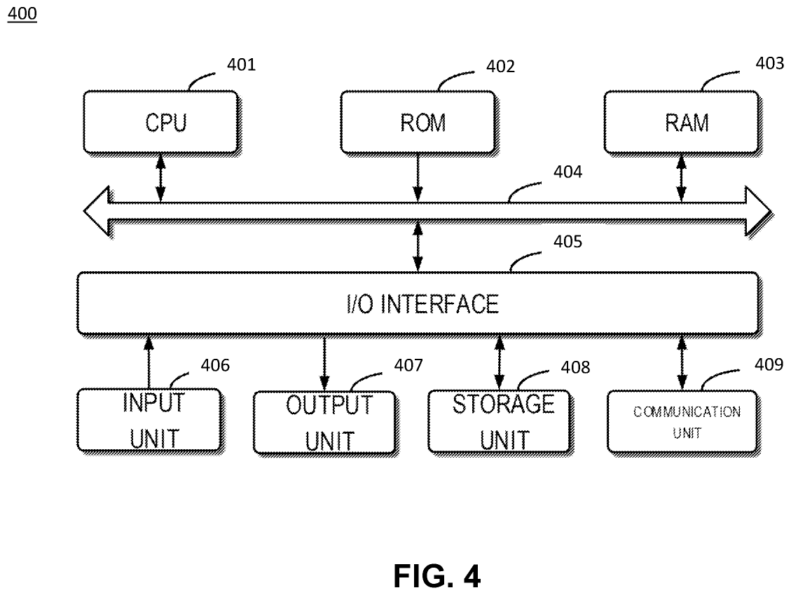

FIG. 4 illustrates a block diagram of an example processing device or, more generally, an information processing system 400 that can be used to implement illustrative embodiments. For example, one or more components in FIGS. 1-3 can comprise a processing configuration such as that shown in FIG. 4 to perform steps/operations described herein. Note that while the components of system 400 are shown in FIG. 4 as being singular components operatively coupled in a local manner, it is to be appreciated that in alternative embodiments each component shown (CPU, ROM, RAM, and so on) can be implemented in a distributed computing infrastructure where some or all components are remotely distributed from one another and executed on separate processing devices. In further alternative embodiments, system 400 can include multiple processing devices, each of which comprise the components shown in FIG. 4.

As shown, the system 400 includes a central processing unit (CPU) 401 which performs various appropriate acts and processing, based on a computer program instruction stored in a read-only memory (ROM) 402 or a computer program instruction loaded from a storage unit 408 to a random-access memory (RAM) 403. The RAM 403 stores therein various programs and data required for operations of the system 400. CPU 401, the ROM 402 and the RAM 403 are connected via a bus 404 with one another. An input/output (I/O) interface 405 is also connected to the bus 404.

The following components in the system 400 are connected to the I/O interface 405, comprising: an input unit 406 such as a keyboard, a mouse and the like; an output unit 407 including various kinds of displays and a loudspeaker, etc.; a storage unit 408 including a magnetic disk, an optical disk, etc.; a communication unit 409 including a network card, a modem, and a wireless communication transceiver, etc. Communication unit 409 allows system 400 to exchange information/data with other devices through a computer network such as the Internet and/or various kinds of telecommunications networks.

Various processes and processing described above may be executed by the CPU 401. For example, in some embodiments, methodologies described herein may be implemented as a computer software program that is tangibly included in a machine-readable medium, e.g., storage unit 408. In some embodiments, part or all of the computer programs may be loaded and/or mounted onto the system 400 via ROM 402 and/or communication unit 409. When the computer program is loaded to the RAM 403 and executed by the CPU 401, one or more steps of the methodologies as described above may be executed.

Illustrative embodiments may be a method, a device, a system, and/or a computer program product. The computer program product may include a computer readable storage medium having computer readable program instructions thereon for causing a processor to carry out aspects of illustrative embodiments.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of illustrative embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages, or other programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Various technical aspects are described herein with reference to flowchart illustrations and/or block diagrams of methods, device (systems), and computer program products according to illustrative embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor unit of a general-purpose computer, special purpose computer, or other programmable data processing device to produce a machine, such that the instructions, when executed via the processing unit of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing device, or other devices to cause a series of operational steps to be performed on the computer, other programmable devices or other devices to produce a computer implemented process, such that the instructions which are executed on the computer, other programmable devices, or other devices implement the functions/acts specified in the flowchart and/or block diagram block or blocks.

The flowchart and block diagrams illustrate architecture, functionality, and operation of possible implementations of systems, methods and computer program products according to various embodiments. In this regard, each block in the flowchart or block diagrams may represent a module, snippet, or portion of code, which includes one or more executable instructions for implementing the specified logical function(s). In some alternative implementations, the functions noted in the block may occur out of the order noted in the figures. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting an object in a two-dimensional image and identifying an object type of the detected object; and
selecting, based on the identified object type of the detected object, an algorithm from a plurality of algorithms configured to transform a two-dimensional image into a three-dimensional model;
wherein the object detection and algorithm selection are performed by at least one processor and at least one memory storing executable computer program instructions.

2. The method of claim 1, further comprising collecting data indicative of system resources usable to execute a selected one of the plurality of algorithms.

3. The method of claim 2, wherein the collected data comprises data indicative of one or more of types, versions, quantities, past utilization, and current availability of the system resources.

4. The method of claim 2, further comprising adapting the selected algorithm based on at least a portion of the collected data.

5. The method of claim 4, wherein adapting the selected algorithm based on at least a portion of the collected data further comprises partitioning the selected algorithm to execute on respective portions of the system resources.

6. The method of claim 4, further comprising executing the adapted algorithm to transform the two-dimensional image into the three-dimensional model.

7. The method of claim 4, further comprising selecting a default algorithm to transform the two-dimensional image into the three-dimensional model when no algorithm is selected from the plurality of algorithms or when the adaptation of the selected algorithm is unsuccessful.

8. An apparatus, comprising:
at least one processor and at least one memory storing computer program instructions wherein, when the at least one processor executes the computer program instructions, the apparatus is configured to:
detect an object in a two-dimensional image and identifying an object type of the detected object; and
select, based on the identified object type of the detected object, an algorithm from a plurality of algorithms configured to transform a two-dimensional image into a three-dimensional model.

9. The apparatus of claim 8, wherein the apparatus is further configured to collect data indicative of system resources usable to execute a selected one of the plurality of algorithms.

10. The apparatus of claim 9, wherein the collected data comprises data indicative of one or more of types, versions, quantities, past utilization, and current availability of the system resources.

11. The apparatus of claim 9, wherein the apparatus is further configured to adapt the selected algorithm based on at least a portion of the collected data.

12. The apparatus of claim 11, wherein adapting the selected algorithm based on at least a portion of the collected data further comprises partitioning the selected algorithm to execute on respective portions of the system resources.

13. The apparatus of claim 11, wherein the apparatus is further configured to execute the adapted algorithm to transform the two-dimensional image into the three-dimensional model.

14. The apparatus of claim 11, wherein the apparatus is further configured to select a default algorithm to transform the two-dimensional image into the three-dimensional model when no algorithm is selected from the plurality of algorithms or when the adaptation of the selected algorithm is unsuccessful.

15. A computer program product stored on a non-transitory computer-readable medium and comprising machine executable instructions, the machine executable instructions, when executed, causing a processing device to perform steps of:
detecting an object in a two-dimensional image and identifying an object type of the detected object; and
selecting, based on the identified object type of the detected object, an algorithm from a plurality of algorithms configured to transform a two-dimensional image into a three-dimensional model.

16. The computer program product of claim 15, further comprising collecting data indicative of system resources usable to execute a selected one of the plurality of algorithms.

17. The computer program product of claim 16, further comprising adapting the selected algorithm based on at least a portion of the collected data.

18. The computer program product of claim 17, wherein adapting the selected algorithm based on at least a portion of the collected data further comprises partitioning the selected algorithm to execute on respective portions of the system resources.

19. The computer program product of claim 17, further comprising executing the adapted algorithm to transform the two-dimensional image into the three-dimensional model.

20. The computer program product of claim 17, further comprising selecting a default algorithm to transform the two-dimensional image into the three-dimensional model when no algorithm is selected from the plurality of algorithms or when the adaptation of the selected algorithm is unsuccessful.
